(19) United States
(12) Patent Application Publication
(10) Pub. No.: US 2025/0232937 A1
(43) Pub. Date: Jul. 17, 2025

(54) ELECTRICAL APPLIANCE AND METHOD FOR SEPARATING AN ELECTRICAL APPLIANCE

(71) Applicant: Siemens Aktiengesellschaft, München (DE)

(72) Inventors: Ekkehard Plechinger, Röckersbühl (DE); Matthias Strobl, Hohenkemnath (DE); Martin Amann, Abensberg/Pullach (DE); Jürgen Reisinger, Schmidgaden (DE)

(21) Appl. No.: 18/854,639

(22) PCT Filed: Apr. 7, 2022
(86) PCT No.: PCT/EP2022/059304

§ 371 Date: Oct. 7, 2024

(51) Int. Cl. H01H 71/02; H01H 9/00

(52) U.S. Cl. CPC H01H 71/025; H01H 2009/0077

(57) ABSTRACT

An electrical appliance contains electronic components which are surrounded by a housing of the electrical appliance. Labels relating to disassembling the electrical appliance are applied to the housing. This increases the recycling rate of products by identifying which parts have value as recyclable parts and which parts have no or limited value and are thus disposable parts.

The invention relates to an electrical device and to a method for separating an electrical device.

The efficient use of resources is one of the key challenges faced by our company. All manufacturers of products, such as electrical devices for example, are therefore encouraged to develop strategies and methods for making products more sustainable. One approach to this is increasing the recycling rate of the products, such as electrical devices for example, by separation yielding unmixed recyclable material as far as possible after the end of the service life or, if possible, enabling components to be reused.

Product development is a process involving a large number of complex challenges and requirements. Innovations have to be developed under considerable time and cost pressure. At present, the focus here is on optimization of function and costs. The “design for disassembly” is an additional requirement for which little space has been provided in the current product development process up to now. This leads to typical products often being very difficult or even impossible to break down after the end of the service life and separation yielding unmixed parts being so complicated that it is dispensed with for economic or technological reasons.

Shredding after the end of the service life is the method for disassembly of products most commonly used in Germany at present. After the shredding, the fragments are subjected to multistage sorting methods. These sorting methods are very complicated. As soon as the products have been shredded, separation yielding unmixed parts is difficult to technically no longer possible to implement.

Valuable components, such as permanent magnets for example, are destroyed during shredding. The shredding releases toxic substances, for example from electrolytic capacitors batteries. Therefore, the granules are already contaminated with various pollutants. The risk of fires and explosions in shredder or sorting installations increases. The legislature attempts to counteract this by way of the permissible limit value concentrations for pollutants in waste from shredders continuously having to be reduced, which in turn leads to an increasing expenditure on sorting.

Typically employed methods, such as magnetic separation, eddy current separation, sensor sorting, various dry and wet separation methods, electrohydraulic comminution, manual sorting, start at a point at which the recycling capability has already been considerably reduced in an irretrievable manner. The technological or energetic complexity for increasing the recycling rate are already extremely high at this point. This shows that breaking down the products into their individual parts is preferable to shredding.

In developing countries to which old electrical devices are often exported nowadays, relevant recyclable and raw materials, such as copper and aluminum, are extracted from the defective devices by setting the devices on fire or by dissolving them in acid baths. Residual parts are often incinerated or deposited in landfill, this resulting in massive damage to humans and the environment.

The object of the invention is therefore to provide an electrical device and a method, which electrical device can be easily separated and broken down into individual parts without special tools or special knowledge.

This object is achieved according to the invention by the electrical device as claimed in claim 1. Advantageous refinements of the device according to the invention are specified in dependent claims 2 to 7. The object is likewise achieved according to the invention by the method for separating an electrical device as claimed in claim 8. An advantageous refinement of the method according to the invention is specified in dependent claim 9.

The electrical device as claimed in claim 1 comprises electronic components which are enclosed by a housing of the electrical device, wherein markings for separating the electrical device are applied to the housing.

It is advantageous here that an efficient disassembly method, which leads to a higher recycling rate, can be carried out owing to the markings. The method may be a universal, economically and technologically simple method. Disassembly can be performed by trained personnel. No specialist knowledge about the design and function of the electrical device is required. Simple marking with symbols provides the relevant information irrespective of language barriers.

In one refinement of the electrical device, the markings comprise a first symbol, which represents a tool, and a second symbol, which indicates the path of the tool.

In a further refinement of the electrical device, the first symbol is provided with a number which indicates the penetration depth of the tool.

In one refinement of the electrical device according to the invention, the first symbol is a saw blade.

In a further refinement of the electrical device, a third symbol is additionally applied to the housing, at a distance from the second symbol, and this third symbol indicates the cutting thickness of the tool to be used. As an alternative, the second symbol of the electrical device according to the invention is in the form of a line, the thickness of which indicates the cutting thickness of the tool.

In a further refinement of the electrical device, after separation of the electrical device into a first part and into a second part, at least one part is provided with markings for separating this part.

The method according to the invention for separating an electrical device according to the invention as claimed in claim 8 comprises the steps of:
reading off the markings;
selecting a tool in accordance with the first symbol of the marking; and
separating the electrical device along the second symbol using the selected tool.

The method according to the invention can be repeatedly applied to at least one part of the electrical device, as a result of which this part is separated.

The above-described properties, features and advantages of this invention, and the way in which they are achieved, will be more clearly and distinctly comprehensible in conjunction with the following description of the embodiments which are explained in more detail in conjunction with the figures, in which:

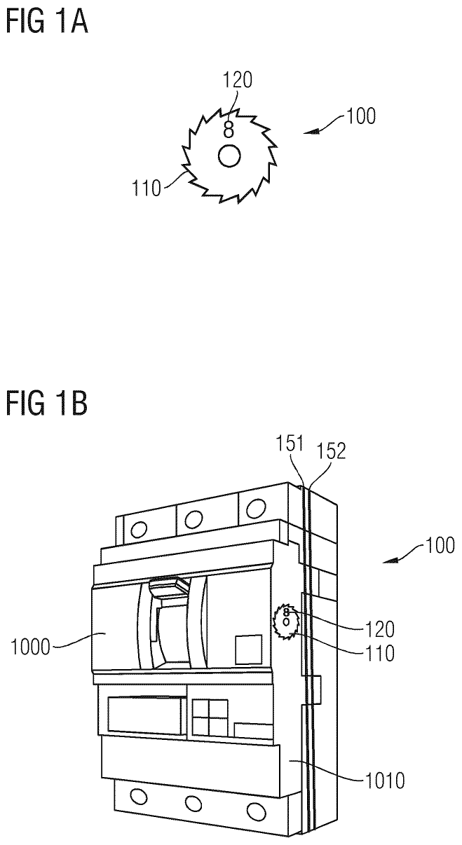

FIGS. 1A and 1B show a marking and an electrical device with markings;

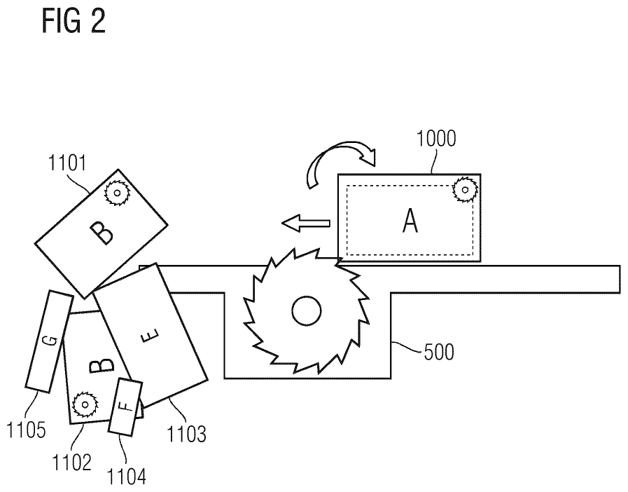

FIG. 2 shows an electrical device after separation;

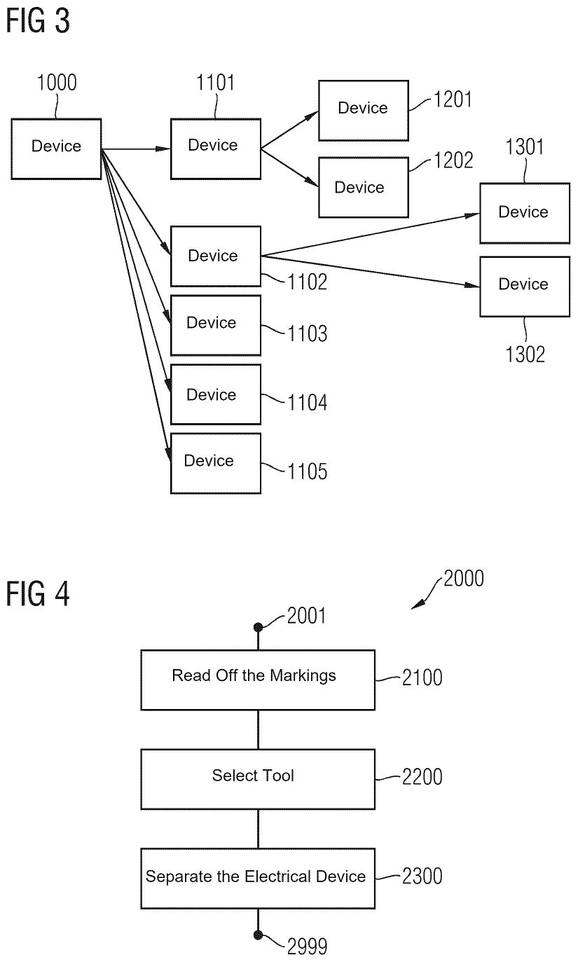

FIG. 3 shows a cascade of separation operations on an electrical device; and

FIG. 4 shows a method according to the invention for separating an electrical device.

FIG. 1B shows an electrical device 1000 comprising electronic components which are enclosed by a housing 1010 of the electrical device 1000. Markings 100; 151, 152 for separating the electrical device 1000 are applied to the housing 1010 of the electrical device 1000.

In this case, the markings 100; 151, 152 comprise a first symbol 100; 110, 120, which represents a tool (500), and a second symbol 151, which indicates the path of the tool (500). The first symbol 100 is illustrated in greater detail in FIG. 1A. The first symbol 100 can be, for example, a saw blade 110. Furthermore, the first symbol 100 can be provided with a number 120 which indicates the penetration depth of the tool (500). In the case of a saw blade 110, as illustrated in FIG. 1A, the number can indicate the penetration depth in mm, 8 mm in accordance with the illustration in FIG. 1A.

The electrical device 1000 should therefore be cut along the second symbol 151 using a saw blade, for example on a circular saw, with a penetration depth of 8 mm in order to separate the electrical device 1000.

The electrical device 1000 can additionally be provided with a third symbol 152 which is applied to the housing 1010 at a distance from the second symbol 151 and in this way indicates the cutting thickness of the tool (500) to be used. For example, in the illustration of FIG. 1B, a saw blade with the cutting thickness corresponding to the distance between the second symbol 151 and the third symbol 152 should be used.

As an alternative, the second symbol 151 can likewise be in the form of a line, the thickness of which indicates the cutting thickness of the tool (500).

FIG. 2 shows the electrical device 1000 according to the invention which is separated by means of a saw blade of a circular saw in accordance with the markings 100; 151, 152. After separation of the electrical device 1000, a first part 1101 and a second part 1102 are produced, these parts in turn likewise being provided with markings 100; 151, 152. Furthermore, electronic components 1103; 1104; 1105 can be removed from the interior of the housing 1010 after separation of the electrical device 1000.

FIG. 3 shows a possible cascading design of the electrical device 1000, this electrical device being broken down into electrical devices 1101; 1102; 1103; 1104; 1105 after a first separation of the electrical device 1000. The electrical device 1101 can in turn be provided with markings 100; 151, 152 and, using this information, broken down into electrical devices 1201; 1202. The same applies to the electrical device 1102, which is likewise provided with markings 100; 151, 152 and therefore can be broken down into electrical devices 1301; 1302.

FIG. 4 shows a method 2000 according to the invention for separating an electrical device 1000. Between the start 2001 and the end 2999, the method 2000 comprises the steps of:
reading off 2100 the markings 100; 151, 152;
selecting 2200 a tool (500) in accordance with the first symbol 100; 110, 120 of the markings 100; 151, 152; and
separating 2300 the electrical device 1000 along the second symbol 151 using the selected tool (500).

The method 200 according to the invention can be repeatedly applied to at least one part 1101; 1102; 1103; 1104; 1105 of the electrical device 1000 and this part 1101; 1102; 1103; 1104; 1105 can likewise be separated.

The electrical device 1000 according to the invention is identified by markings 100; 151, 152 on the outside of the housing 1010, these markings containing information for disassembly. A small amount of information is sufficient. The manufacturer specifications ensure that potentially hazardous objects or recyclable components are not situated in the separating or sawing region. For example, the first symbol 100, a saw blade 110, can be provided with a number 120 which signals that the product is a “DA cut” product (disassembly cut) and the number 120 indicates the recommended sawing depth in mm. The encircling marking 151 on the housing 1010 indicates the course of the sawing cut. Furthermore, the maximum recommended saw blade width can also be indicated or this can be displayed by a third symbol 152. The first symbol 100; 110, 120 can be made in a typical, conspicuous color, for example yellow.

The electrical device 1000 is disassembled by deliberate sawing cuts. This can be performed, for example, by a simple circular table saw or by a hand saw. After the sawing process, the housing parts, casings and structuring components are broken down into readily processable individual parts. Individual components and further components to be disassembled are now exposed in intact form and can be broken down further by further sawing cuts if required. The process is continued until all the components with markings 100; 151, 152 have been separated.

1-9. (canceled)

10. An electrical device, comprising:
a housing;
electronic components enclosed by said housing; and
markings for separating the electrical device are disposed on said housing.

11. The electrical device according to claim 10, wherein said markings include a first symbol, which represents a tool, and a second symbol, which indicates a path of the tool.

12. The electrical device according to claim 11, wherein said first symbol is provided with a number which indicates a penetration depth of the tool.

13. The electrical device according to claim 11, wherein said first symbol is a symbol of a saw blade.

14. The electrical device according to claim 11, wherein said markings include a third symbol disposed on said housing, at a distance from said second symbol, and in this way indicates a cutting thickness of the tool to be used.

15. The electrical device according to claim 11, wherein said second symbol is in a form of a line, a thickness of the line indicates a cutting thickness of the tool.

16. The electrical device according to claim 11, wherein, after separation of the electrical device into a first part and into a second part, at least one of the first and second parts is provided with further markings for separating the first and/or second part.

17. A method for separating the electrical device according to claim 11, which comprises the steps of:
reading off the markings;
selecting a tool in accordance with a first symbol of the markings; and
separating the electrical device along a second symbol of the markings using the tool selected.

18. The method according to claim 17, which further comprises repeating application of the steps in the method to at least one part of the electrical device resulting in said part being separated.
